(19) United States
(12) Patent Application Publication
(10) Pub. No.: US 2019/0384344 A1
(43) Pub. Date: Dec. 19, 2019

(54) Circuit for Generating a Negative Higher Order Temperature Coefficient Current

(71) Applicant: Dialog Semiconductor (UK) Limited, London (GB)

(72) Inventors: Ambreesh Bhattad, Swindon (GB); Rainer Krenzke, Esslingen (DE); Frank Kronmueller, Neudenau (DE)

(21) Appl. No.: 16/371,686

(22) Filed: Apr. 1, 2019

(30) Foreign Application Priority Data
Jun. 15, 2018 (DE) 102018209686.4

(51) Int. Cl. G05F 3/26; G05F 3/22; G05F 1/46

(52) U.S. Cl. CPC G05F 3/267; G05F 1/463; G05F 3/222

(57) ABSTRACT

A current generator circuit and a method to provide a negative higher order temperature coefficient, nHOTC, current is presented. The circuit has a current source to provide a reference current. Furthermore, the circuit has a MOS current mirror to derive a current at an output of the MOS current mirror from the reference current at an input of the MOS current mirror. In addition, the circuit has a bipolar current mirror to derive a current at an output of the bipolar current mirror from the reference current at an input of the bipolar current mirror. The output of the MOS current mirror and the output of the bipolar current mirror are arranged in series, to provide a combined current. The bipolar current mirror exhibits a mirror ratio 1:k, with 0<k<1. Furthermore, the circuit has an output to provide the nHOTC current based on the combined current.

### TECHNICAL FIELD

The present document relates to a current generator which is configured to provide a temperature dependent current.

### BACKGROUND

Solid state circuit elements, such as transistors, typically have certain properties that depend on temperature. By way of example, the quiescent or leakage current of a circuit (e.g. a low drop out, LDO, voltage regulator) may be dependent on temperature, thereby affecting the power efficiency of the circuit.

In order to compensate the temperature-dependency of a solid state circuit element, current generators may be used, which are configured to generate a current that exhibits a similar or complementary temperature-dependency as the solid state circuit element.

### SUMMARY

The present document addresses the technical problem of providing, in a robust and reliable manner, a current generator which is configured to generate a current that exhibits a negative higher order temperature coefficient (nHOTC) (i.e. that increases with decreasing temperature).

According to an aspect, a current generator circuit which is configured to provide a negative higher order temperature coefficient, nHOTC, current is described. The circuit comprises a current source which is configured to provide a reference current.

Furthermore, the circuit comprises a MOS current mirror which is configured to derive a current at an output of the MOS current mirror from the reference current at an input of the MOS current mirror. In addition, the circuit comprises a bipolar current mirror which is configured to derive a current at an output of the bipolar current mirror from the reference current at an input of the bipolar current mirror. The output of the MOS current mirror and the output of the bipolar current mirror are arranged in series, to provide a combined current. The bipolar current mirror exhibits a mirror ratio 1:k, with 0<k<1. Furthermore, the circuit comprises output means for providing the nHOTC current based on the combined current.

According to a further aspect, a method for providing a negative higher order temperature coefficient, nHOTC, current is described. The method comprises providing a reference current. Furthermore, the method comprises mirroring the reference current using a MOS current mirror which is configured to derive a current at an output of the MOS current mirror from the reference current at an input of the MOS current mirror. In addition, the method comprises mirroring the reference current using a bipolar current mirror which is configured to derive a current at an output of the bipolar current mirror from the reference current at an input of the bipolar current mirror. The output of the MOS current mirror and the output of the bipolar current mirror are arranged in series, to provide a combined current. Furthermore, the bipolar current mirror exhibits a mirror ratio 1:k, with 0<k<1. In addition, the method comprises providing the nHOTC current based on the combined current.

It should be noted that the methods and systems including its preferred embodiments as outlined in the present document may be used stand-alone or in combination with the other methods and systems disclosed in this document. In addition, the features outlined in the context of a system are also applicable to a corresponding method. Furthermore, all aspects of the methods and systems outlined in the present document may be arbitrarily combined. In particular, the features of the claims may be combined with one another in an arbitrary manner.

In the present document, the term “couple” or “coupled” refers to elements being in electrical communication with each other, whether directly connected e.g., via wires, or in some other manner.

### BRIEF DESCRIPTION OF THE DRAWINGS

The invention is explained below in an exemplary manner with reference to the accompanying drawings, wherein

FIG. 1A illustrates an example block diagram of an LDO regulator;

FIG. 1B illustrates the example block diagram of an LDO regulator in more detail;

FIG. 2A shows an example current generator circuit:

FIG. 2B shows an example current generator circuit comprising a matching resistor;

FIG. 3 shows an example temperature dependent current; and

FIG. 4 shows a flow chart of an example method for generating a nHOTC current.

### DESCRIPTION

As indicated above, the present document is directed at the technical problem of providing a current generator which is configured to generate a current with nHOTC characteristic.

A higher order temperature dependency (which is higher than the first order) enables functions that have no or negligible effect at room temperature and are only effective on increased and/or decreased temperatures. This enables the provision of circuits which exhibit a relatively low quiescent current under standard conditions, and to perform current compensation only at increased and/or decreased temperatures in order to achieve a desired operation of the circuits. By doing this, the power consumption of circuits can be reduced.

In the present document a current generator is described which allows for continuous operation in order to avoid a metastable or hysteretic behavior of the system which comprises the current generator. In particular, the currents may be increased in a continuous manner with increasing and/or decreasing temperature. The current generator exhibits predictable properties to generate a current with high order temperature dependency. Furthermore, the current generator exhibits matching properties that allow for a reliable scaling with lower order temperature coefficient (TC) currents. In particular, the current generator exhibits an increased gain, as a function of temperature (compared to a PTAT behavior). As a result of this, matching properties are improved. This may e.g. be beneficial when adding current for achieving complex waveforms.

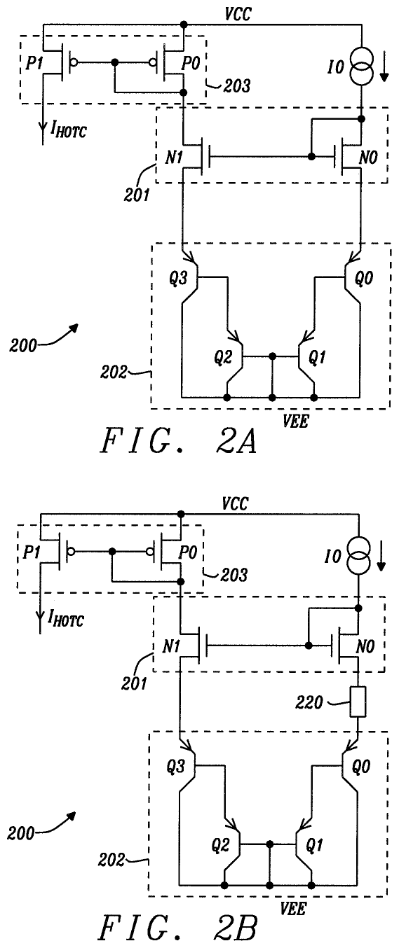

FIG. 2A shows an example current generator circuit 200. The circuit 200 comprises a MOS current mirror 201 which is formed by the MOS (metal oxide semiconductor) transistors N0 and N1. Furthermore, the circuit 200 comprises a current source, which is configured to provide a bias or reference current I0. The MOS current mirror 201 is configured to mirror the reference current IO from the input side of the MOS current mirror 201 to the output side of the MOS current mirror 201. The MOS transistors NO and N1 are different from one another in terms of bulk/source connection, thereby enabling a steep temperature dependency of the current which is provided by the current generator circuit 200. By way of example, one of the MOS transistors (e.g. N0) may exhibit a bulk or body effect (with the bulk-source voltage V_{Bs>}0). The other one of the MOS transistors (e.g. N1) may exhibit a bulk-source voltage V_{BS}=0

Furthermore, the current generator circuit 200 comprises a bipolar current mirror 202 which comprises bipolar transistors Q0, Q1, Q2, Q3. In particular, the bipolar current mirror 202 of FIG. 2A comprises a first sub current mirror which is formed by the bipolar transistors Q1 and Q2 and a second sub current mirror which is formed by the bipolar transistors Q0 and Q3. The bipolar current mirror 202 is configured to mirror the reference current IO from the input side of the bipolar current mirror 202 to the output side of the bipolar current mirror 202. The first and second sub current mirrors and/or the bipolar current mirror 202 exhibit a mirror ratio of 1:k, wherein k is smaller than one and greater than zero.

The output side of the MOS current mirror 201 and the output side of the bipolar current mirror 202 are arranged in series, such that the output sides of both current mirrors 201, 202 interact, to provide a joint or combined output current. This output current may be mirrored using a (PMOS) current mirror 203, in order to provide the HOTC current I_{HOTC}.

FIG. 2B shows a current generator circuit 200 comprising an additional matching resistance 220 between the input side of the MOS current mirror 201 and the input side of the bipolar current mirror 202. As a result of this, matching properties may be improved. Improved matching of HOTC current may be beneficial when combing the HOTC current with lower order TC current with reduced variation.

The current generator circuit 200 may be used to generate complex waveforms for bias currents (as a function of temperature). For this purpose, the current generator circuit 200 may be combined with other current generator circuits which may be configured to generator ZTAT (zero to absolute temperature), PTAT (proportional to absolute temperature) and/or CTAT (complimentary to absolute temperature) currents. FIG. 3 illustrates as an example a bias current 300 at a function of temperature, which is generated using a combination of a HOTC and a nHOTC bias current.

Hence, bias currents may be generated in order to overcome various different temperature dependent deficiencies of integrated circuits. For example, a higher order coefficient current (HOTC) circuit may be used to bias a MOS based amplifier circuit in order to boost transconductance over temperature.

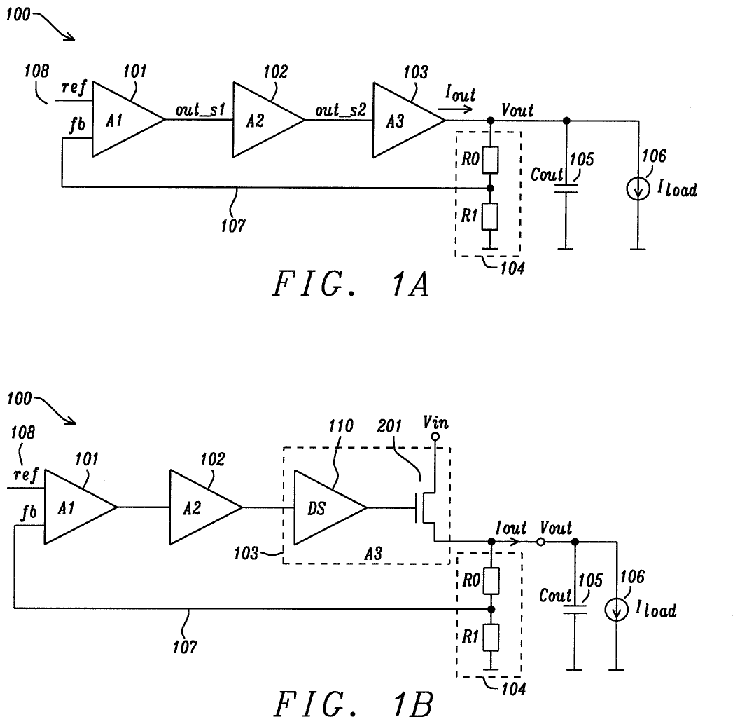

FIG. 1A illustrates a typical LDO regulator 100. The LDO regulator 100 comprises an output amplification stage or output stage 103, comprising e.g. a field-effect transistor (FET), at the output and a differential or first amplification stage 101 (also referred to as error amplifier) at the input. A first input (fb) 107 of the differential amplification stage 101 receives a fraction of the output voltage VOUT determined by the voltage divider 104 comprising resistors R0 and R1. The second input (ref) to the differential amplification stage 101 is a stable voltage reference Vref 108 (also referred to as the bandgap reference). If the output voltage VOUT changes relative to the reference voltage Vref (or to a setpoint voltage proportional to the reference voltage), the drive voltage to the output amplification stage, e.g. to the power FET, changes by a feedback mechanism called main feedback loop to maintain a constant output voltage VOUT.

The LDO regulator 100 of FIG. 1A further comprises an additional intermediate amplification stage 102 configured to amplify the differential output voltage of the differential amplification stage 101. An intermediate amplification stage 102 may be used to provide an additional gain within the amplification path. Furthermore, the intermediate amplification stage 102 may provide a phase inversion.

In addition, the LDO regulator 100 is typically used in conjunction with an output capacitance Cout (also referred to as output capacitor or stabilization capacitor) 105 parallel to the load 106. The output capacitor 105 is used to stabilize the output voltage VOUT subject to a change of the load 106, in particular subject to a change of the requested load current or output current Iload/IOUT. The capacitor value or capacitance of the output capacitor 105 may be selected depending on the application.

FIG. 1B illustrates the block diagram of a LDO regulator 100, wherein the output amplification stage 103 is depicted in more detail. In particular, the pass transistor or pass device 201 and the driver stage 110 of the output amplification stage 103 are shown. Typical parameters of an LDO regulator 100 are a supply voltage of 3V, an output voltage of 2V, and an output current or load current ranging from 1 mA to 100 or 200 mA and even up to very high output currents of 1 A, 1.5 A or more. Other configurations are possible.

The current generator circuit 200 described in the present document may be configured to generate the bias current and/or the quiescent current used for one or more of the components of a LDO regulator 100 (notably for the pass transistor 201 and/or of the differential amplifier 101). For this purpose, the current generator circuit 200 and the voltage regulator 100 may be implemented on the same circuit board. As a result of this, the feedback loop stability of a voltage regulator 100 may be increased.

The current generator circuit 200 described in the present document enables a solid state circuit to operate at its optimal operation point for various different temperatures (notably at relatively low temperatures and/or at relatively high temperatures). In particular, the current generator circuit 200 may be used to increase loop stability or to optimize other loop critical parameters such as the delay of comparators.

Hence, a current generator circuit 200 is described which is configured to provide a negative higher order temperature coefficient (nHOTC) current. The nHOTC current may increase with decreasing temperature (with an order of temperature dependency which is greater than one). The nHOTC current may be used to provide a temperature dependent bias current (e.g. for a voltage regulator 100). The current generator circuit 200 may be implemented on the same circuit board as the circuit which is using the nHOTC current, thereby enabling a stable and reliable temperature compensation.

The current generator circuit 200 comprises a current source which is configured to provide a (constant) reference current I0. The reference current I0 may be independent from the temperature.

Furthermore, the current generator circuit 200 comprises a MOS current mirror 201 which is configured to derive a current at the output of the MOS current mirror 201 from the reference current I0 at the input of the MOS current mirror 201. For this purpose, the input of the MOS current mirror 201 may be arranged in series with the current source.

The MOS current mirror 201 may comprise an input MOS transistor N0 (at the input of the MOS current mirror 201) and an output MOS transistor N1 (at the output of the MOS current mirror 201). The input MOS transistor N0 and the output MOS transistor N1 may each comprise one or more NMOS transistors. Hence, the MOS current mirror 201 may be an NMOS current mirror.

The input MOS transistor N0 and the output MOS transistor N1 may differ in terms of bulk/source connections of the MOS transistors. By doing this, a steep temperature dependency (i.e. a relatively high order) of the nHOTC current may be achieved.

Furthermore, the current generator circuit comprises a bipolar current mirror 202 which is configured to derive a current at the output of the bipolar current mirror 202 from the reference current I0 at the input of the bipolar current mirror 202. For this purpose, the input of the bipolar current mirror 202 may be arranged in series with the current source. The bipolar current mirror 202 may comprise two or more bipolar transistors. The input of the MOS current mirror 201 and the input of the bipolar current mirror 202 may be arranged in series. Furthermore, the output of the MOS current mirror 201 and the output of the bipolar current mirror 202 may be arranged in series, to provide a combined current.

In addition, the current generator circuit 200 comprises output means 203 for providing the nHOTC current based on the combined current. In particular, the current generator circuit 200 may comprise a current mirror, notably a PMOS current mirror, which is configured to derive the nHOTC current at the output of the PMOS current mirror based on the combined current at the input of the PMOS current mirror. The PMOS current mirror may be arranged in series with the output of the bipolar current mirror and the output of the MOS current mirror.

The bipolar current mirror 202 may exhibit a mirror ratio 1:k, with 0<k<1. In other words, the bipolar current mirror 202 may be configured to attenuate the current at the input of the bipolar current mirror 202 by the factor k, thereby providing the current at the output of the bipolar current mirror 202. As a result of this, an efficient and reliable nHOTC current generator may be provided.

In particular, the bipolar current mirror 202 may comprise a first current mirror comprising a first bipolar transistor Q1 and a second bipolar transistor Q2. In other words, the bipolar current mirror 202 may comprise a first bipolar transistor Q1 and a second bipolar transistor Q2. The first bipolar transistor Q1 and the second bipolar transistor Q2 may exhibit a size ratio of 1:k. In other words, the second bipolar transistor Q2 may exhibit a size which is k times the size of the first bipolar transistor Q1. As a result of this, an efficient and reliable nHOTC current generator may be provided.

The base of the first bipolar transistor Q1 may be (directly) coupled to the base of the second bipolar transistor Q2. Furthermore, the base of the first bipolar transistor Q1 may be (directly) coupled to the collector of the first bipolar transistor Q1. In addition, the base of the second bipolar transistor Q2 may be (directly) coupled to the collector of the second bipolar transistor Q2.

The bipolar current mirror 202 may comprise a forth bipolar transistor Q0 and a third bipolar transistor Q3. The base of the forth bipolar transistor Q0 may be (directly) coupled to the emitter of the first bipolar transistor Q1. The base of the third bipolar transistor Q3 may be (directly) coupled to the emitter of the second bipolar transistor Q1. Furthermore, the forth bipolar transistor Q0 and the third bipolar transistor Q3 may exhibit a size ratio of 1:k. In other words, the third bipolar transistor Q3 may exhibit a size which is k times the size of the fourth bipolar transistor Q0. As a result of this, an efficient and reliable nHOTC current generator may be provided.

The emitter of the forth bipolar transistor Q0 may correspond to the input of the bipolar current mirror 202. Furthermore, the emitter of the third bipolar transistor Q3 may correspond to the output of the bipolar current mirror 202.

The collector of the forth bipolar transistor Q0 may be (directly) coupled to the collector of the first bipolar transistor Q1, and the collector of the third bipolar transistor Q3 may be (directly) coupled to the collector of the second bipolar transistor Q2.

The current generator circuit 200 may comprise a matching resistor 220 arranged between the input of the MOS current mirror 201 and the input of the bipolar current mirror 202. As a result of this, matching properties of the current generator circuit 200 may be improved.

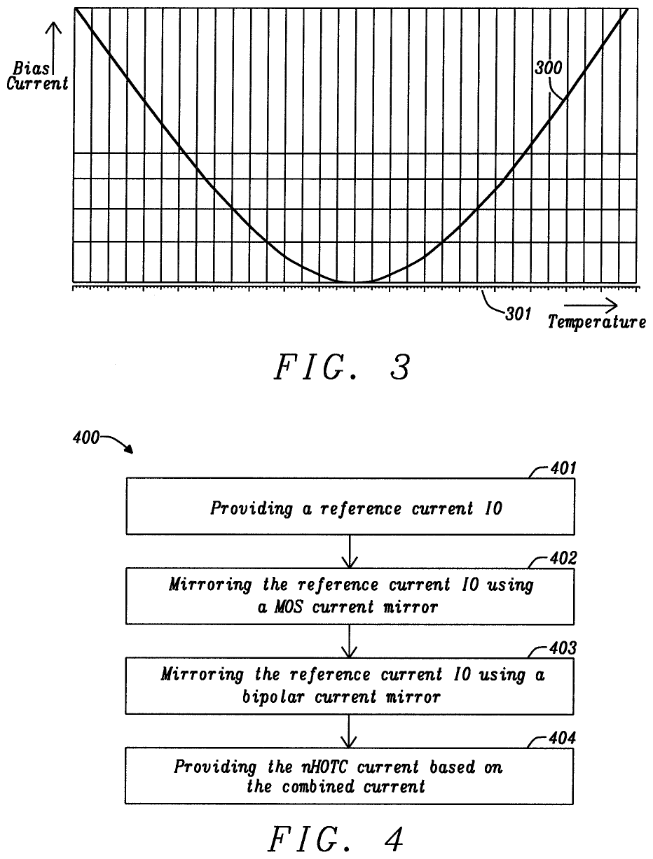

FIG. 4 shows a flow chart of an example method 400 for providing a negative higher order temperature coefficient, nHOTC, current. The method 400 comprises providing 401 a reference current I0. Furthermore, the method 400 comprises mirroring 402 the reference current I0 using a MOS current mirror 201 which is configured to derive a current at an output of the MOS current mirror 201 from the reference current I0 at an input of the MOS current mirror 201. In addition, the method 400 comprises mirroring 403 the reference current I0 using a bipolar current mirror 202 which is configured to derive a current at an output of the bipolar current mirror 202 from the reference current I0 at an input of the bipolar current mirror 202. The output of the MOS current mirror 201 and the output of the bipolar current mirror 202 are arranged in series, to provide a combined current. Furthermore, the bipolar current mirror 202 exhibits a mirror ratio 1:k, with 0<k<1. In addition, the method 400 comprises providing 404 the nHOTC current based on the combined current.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1) A current generator circuit which is configured to provide a negative higher order temperature coefficient, nHOTC, current; wherein the circuit comprises,
a current source configured to provide a reference current;
a MOS current mirror configured to derive a current at an output of the MOS current mirror from the reference current at an input of the MOS current mirror;
a bipolar current mirror configured to derive a current at an output of the bipolar current mirror from the reference current at an input of the bipolar current mirror; wherein the output of the MOS current mirror and the output of the bipolar current mirror are arranged in series, to provide a combined current; wherein the bipolar current mirror exhibits a mirror ratio 1:k, with 0<k<1; and
output means for providing the nHOTC current based on the combined current.

2) The current generator circuit of claim 1, wherein the input of the MOS current mirror and the input of the bipolar current mirror are arranged in series.

3) The current generator circuit of claim 2, wherein the current generator circuit comprises a matching resistor arranged between the input of the MOS current mirror and the input of the bipolar current mirror.

4) The current generator circuit of claim 1, wherein
the MOS current mirror comprises an input MOS transistor and an output MOS transistor; and
the input MOS transistor and the output MOS transistor differ in terms of bulk/source connections.

5) The current generator circuit of claim 1, wherein
the bipolar current mirror comprises a first current mirror comprising a first bipolar transistor and a second bipolar transistor; and
the first bipolar transistor and the second bipolar transistor exhibit a size ratio of 1:k.

6) The current generator circuit of claim 5, wherein
the base of the first bipolar transistor is coupled to the base of the second bipolar transistor;
the base of the first bipolar transistor is coupled to the collector of the first bipolar transistor; and
the base of the second bipolar transistor is coupled to the collector of the second bipolar transistor;

7) The current generator circuit of claim 5, wherein
the bipolar current mirror comprises a forth bipolar transistor and a third bipolar transistor;
the base of the forth bipolar transistor is coupled to the emitter of the first bipolar transistor;
the base of the third bipolar transistor is coupled to the emitter of the second bipolar transistor; and
the forth bipolar transistor and the third bipolar transistor exhibit a size ratio of 1:k.

8) The current generator circuit of claim 7, wherein
the emitter of the forth bipolar transistor corresponds to the input of the bipolar current mirror; and
the emitter of the third bipolar transistor corresponds to the output of the bipolar current mirror.

9) The current generator circuit of claim 8, wherein
the collector of the forth bipolar transistor is coupled to the collector of the first bipolar transistor; and
the collector of the third bipolar transistor is coupled to the collector of the second bipolar transistor.

10) The current generator circuit of claim 1, wherein
the MOS current mirror comprises NMOS transistors; and/or
the MOS current mirror is an NMOS current mirror.

11) The current generator circuit of claim 1, wherein the output means comprise a current mirror, notably a PMOS current mirror.

12) A method for providing a negative higher order temperature coefficient, nHOTC, current; wherein the method comprises,
providing a reference current;
mirroring the reference current using a MOS current mirror configured to derive a current at an output of the MOS current mirror from the reference current at an input of the MOS current mirror;
mirroring the reference current using a bipolar current mirror configured to derive a current at an output of the bipolar current mirror from the reference current at an input of the bipolar current mirror; wherein the output of the MOS current mirror and the output of the bipolar current mirror are arranged in series, to provide a combined current; wherein the bipolar current mirror exhibits a mirror ratio 1:k, with 0<k<1; and
providing the nHOTC current based on the combined current.
